(19) United States
(12) Patent Application Publication
(10) Pub. No.: US 2009/0290353 A1
(43) Pub. Date: Nov. 26, 2009

(54) Lamp Heat Dissipating Structure

(76) Inventor: Tony CHOU, Taipei City (TW)

Correspondence Address: FRENKEL & ASSOCIATES, 3975 UNIVERSITY DR., STE. 330, FAIRFAX, VA, 22030, US

(21) Appl. No.: 12/125,194

(22) Filed: May 22, 2008

(51) Int. Cl. F21V 29/00

(52) U.S. Cl. 362/294; 362/373

(57) ABSTRACT

The present invention is related to a heat dissipating structure for a lamp including at least an illuminating element, a lamp base, a metal housing, a ring-shaped coil and a metal base, wherein through the great heat conductivity of the metal housing, the heat can be averagely distributed over the surface thereof for emitting outwardly so as to reduce the lamp temperature during operation and extend the life time of lamp.

### FIELD OF THE INVENTION

The present invention is related to a heat dissipating structure for a lamp, and more particularly to a heat dissipating structure for a lamp base, so as to provide a heat dissipating function therefor.

### BACKGROUND OF THE INVENTION

Currently, the main illumination instruments are still incandescent lamps (and also the energy saver fluorescent lamps) since most families, offices and public places still employ the base structure for the incandescent lamps, and also the newly developed LED illuminations are still not popular. A conventional lamp, such as Taiwan Patent No. M305303, entitled “Structure Improvement of Lamps”, is composed of a lamp housing, a positioning base, a fluorescent tube, a conducting head, a circuit board, and electronic components connected to the circuit board, wherein the lamp housing is consisted of two light permeable half plastic housings, and the two light permeable half housings have plural heat dissipating holes mounted thereon for providing heat dissipating function. However, since the fluorescent tube is encapsulated in the lamp housing and the positioning base does not additionally provide the heat dissipating function, the exhausting of the heat produced by the lamp tube through the heat dissipating holes has to be achieved by air convection. But, based on the physical principle that hot air rises up, it is obvious the heat dissipating holes which are located at the lower portion of the lamp housing can not efficiently exhaust the heat. Besides, the encapsulated structure also lowers down the heat dissipating efficiency. Therefore, this is still improvable. Another disclosure, Taiwan Patent No. M265535, entitled “Bulb Type of Daylight Lamp Composite Structure”, includes a daylight tube, a metal assemblage, an outer shell, a component for assembling and fixing, and a ballast and starter. In this disclosure, although the daylight tube is not sealed for providing a better heat dissipating effect, the ballast and starter is accommodated in the assembling and fixing component, which only provides several let in holes for passing through the air and providing slight heat dissipating effect, and thus, the daylight tube still might become overheated. Some other similar disclosures are Taiwan Patent No. M272222, entitled “Energy Saver Lamp” and Taiwan Patent No. M275529, entitled “Anion Energy Saver Lamp”, but identically, the heat dissipating efficiency thereof is still improvable for preventing the overheated situation from reducing the life thereof.

### SUMMARY OF THE INVENTION

The object of the present invention is to provide a lamp structure with great heat dissipating capability, so as to increase the life time of the lamp.

The present invention is related to a heat dissipating structure for a lamp including an illuminating element, a lamp base, a metal housing, a ring-shaped coil and a metal base, wherein the metal housing has a great heat conducting capability, the illuminating element is mounted on the lamp base, which is engaged with the metal housing, a ring-shaped coil which is connected with plural electronic components is further mounted between the metal housing and the lamp base, the ring-shaped coil is electrically connected to the illuminating element and the metal base, and the metal base is electrically connected to a power source, so that through a conduction of the metal base, the ring-shaped coil can acquire and transform electricity to provide to the illuminating element for operation. Therefore, through the great heat conductivity of the metal housing, the heat can be averagely distributed over the surface thereof for emitting outwardly so as to reduce the lamp temperature during operation.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a decomposition drawing of the present invention;

FIG. 2 is a three-dimensional drawing of the present invention;

FIG. 3A is a sectional view of the present invention;

FIG. 3B is a partially magnified sectional view of the present invention;

FIG. 4 is a schematic view showing the assembling between a connecting element and a metal housing; and

FIG. 5 is a three-dimensional drawing in another embodiment of the present invention.

### DESCRIPTION OF THE PREFERRED EMBODIMENT

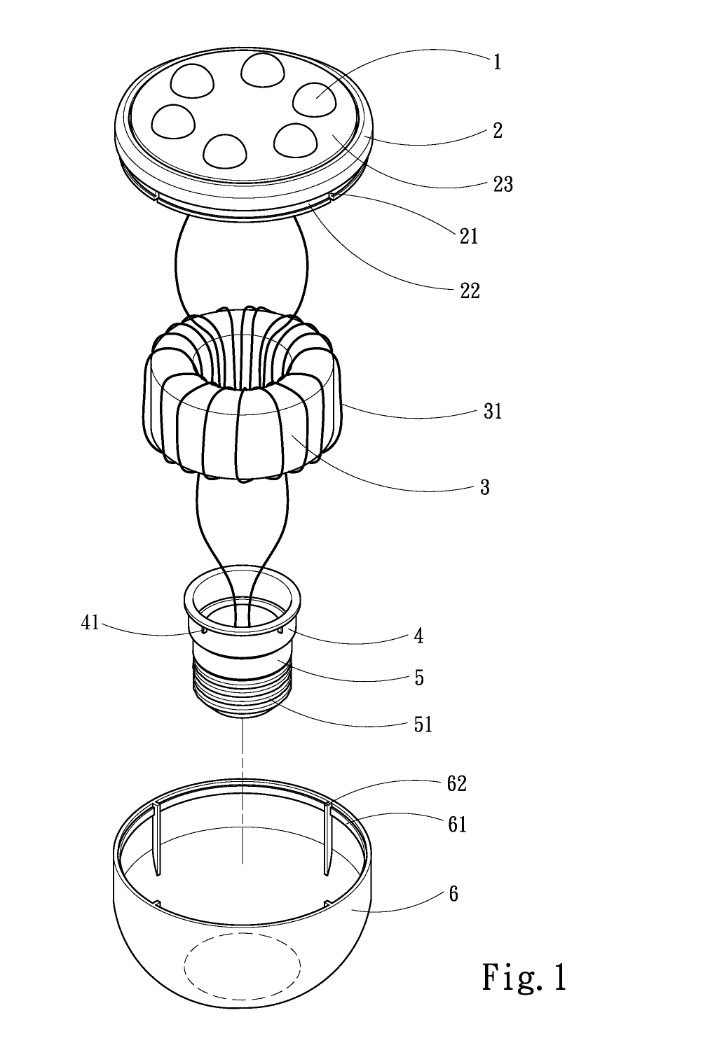

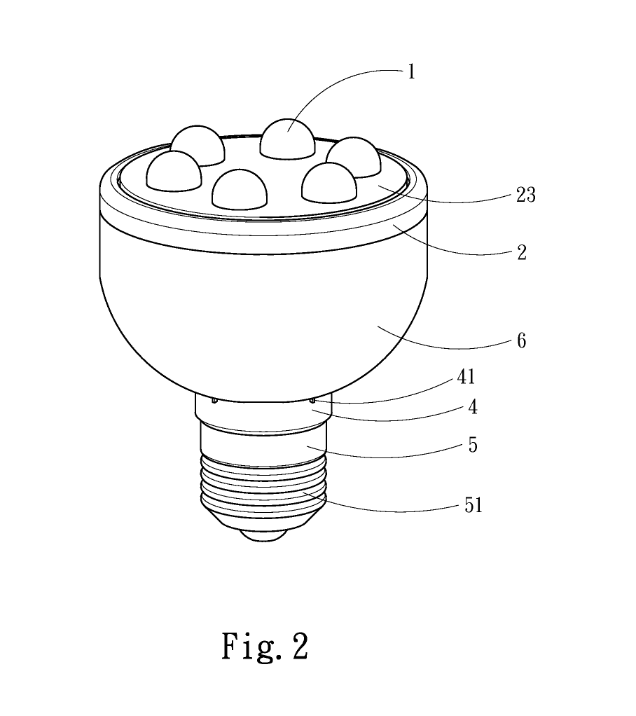

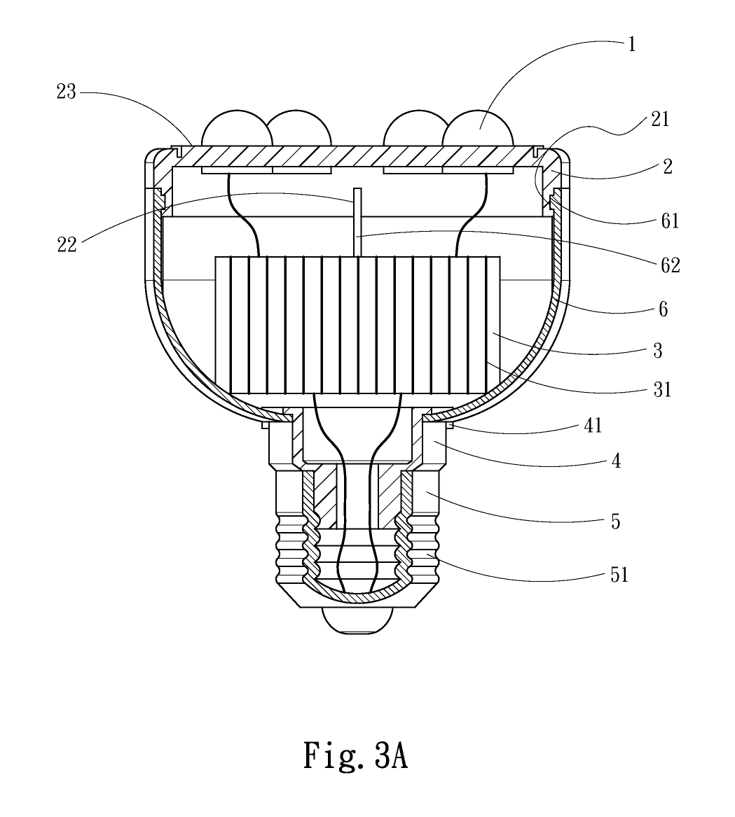

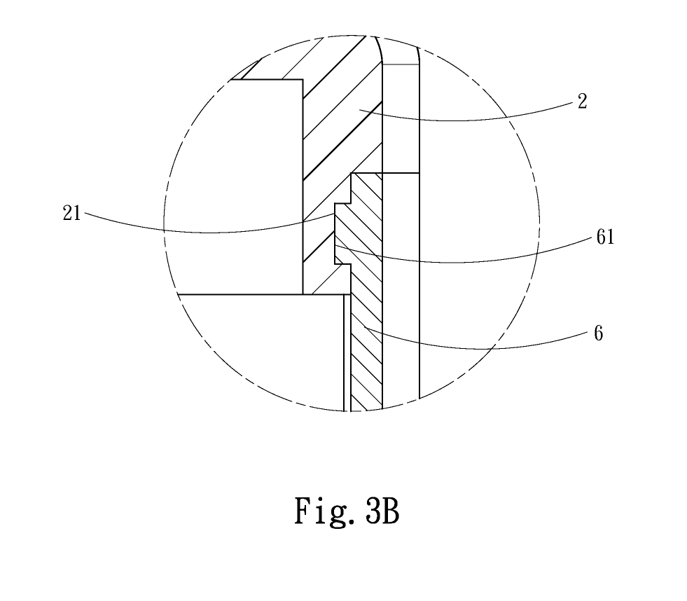

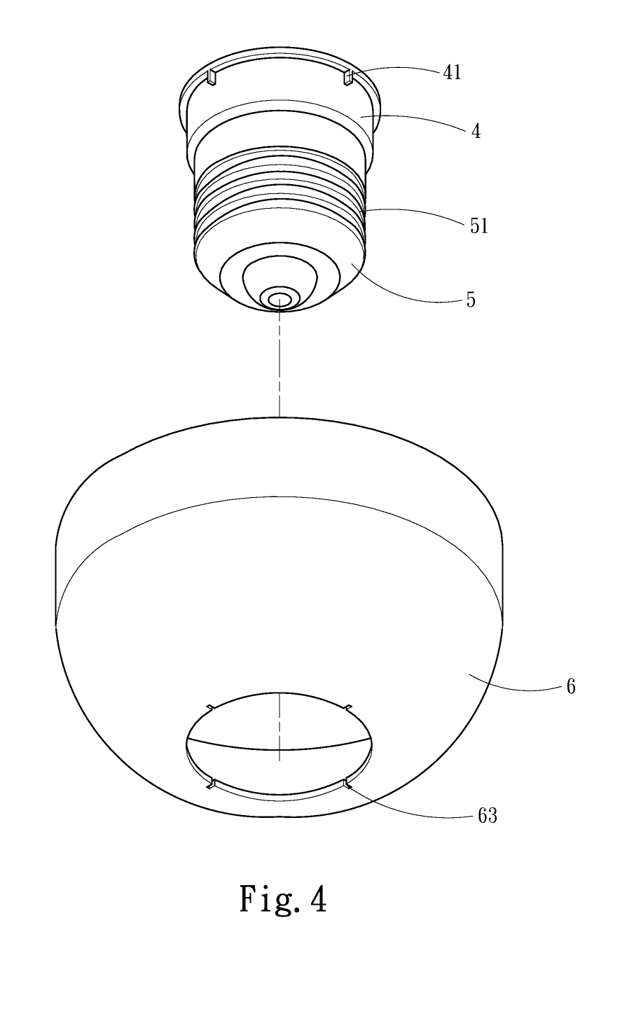

Please refer to FIG. 1, FIG. 2, FIG. 3A, FIG. 3B and FIG. 4. A lamp of the present invention includes an illuminating element 1, a lamp base 2, a metal housing 6, a ring-shaped coil 3 and a metal base 5. The metal housing 6 has a great heat conducting capability and includes two opposite openings, wherein one smaller opening is provided for passing therethrough the metal base 5. Between the metal base 5 and the metal housing 6, a connecting element 4 is further provided for insulation and protection, wherein two ends of the connecting element 4 are respectively adhered to or screwed on the metal base 5 and the metal housing 6, and a male engaging portion 41 is provided on the connecting element 4 for engaging with a female engaging portion 63, which is mounted on the metal housing 6 at a corresponding position thereto, so as to assemble the connecting element 4 and the metal housing 6 together (as shown in FIG. 4). Inside the metal housing 6, the ring-shaped coil 3 (as shown in FIG. 3A) with wire 31 wound thereon is accommodated, and also other electronic components. The other larger opening of the metal housing 6 has at least a protruded ring 61 and at least a male engaging portion 62 mounted on the inner edge thereof, and the circumference of the lamp base 2 has an indent trough 21 and a female engaging portion 22 respectively corresponding thereto. Therefore, through the engagements between the indent trough 21 and the protruded ring 61 and between the female engaging portion 22 and the male engaging portion 62, the lamp base 2 can be assembled onto the larger opening of the metal housing 6 (as shown in FIG. 3B), so as to form an encapsulated structure. The illuminating element 1 is assembled on a bearing surface 23 of the lamp base 2 for forming an integral lamp assembly (as shown in FIG. 2). The illuminating element 1 is electrically connected to one end of the wire 31 wound on the ring-shaped coil 3, and the other end of the wire 31 is electrically connected to the metal base 5. The metal base 5 has threads 51 mounted thereon. After the metal base 5 is contacted with power source and conducted thereby, through the ring-shaped coil 3 and other electronic components, the electricity can be transformed and transmitted to the illuminating element 1 (as shown in FIG. 1, which can be plural LEDs) for illumination. Furthermore, the male engaging portions 62, 41 can have a slat-like shape and the female engaging portions 22, 63 can be a slot perfectly matched therewith, so that the heat produced from the illuminating element 1 cooperating with the ring-shaped coil 3 and other electronic components can be conducted to the metal housing 6, which can be made of aluminum alloy or copper alloy. Therefore, through the great heat conductivity of the metal housing 6, the heat can be averagely distributed over the surface thereof for emitting outwardly so as to reduce the lamp temperature during operation.

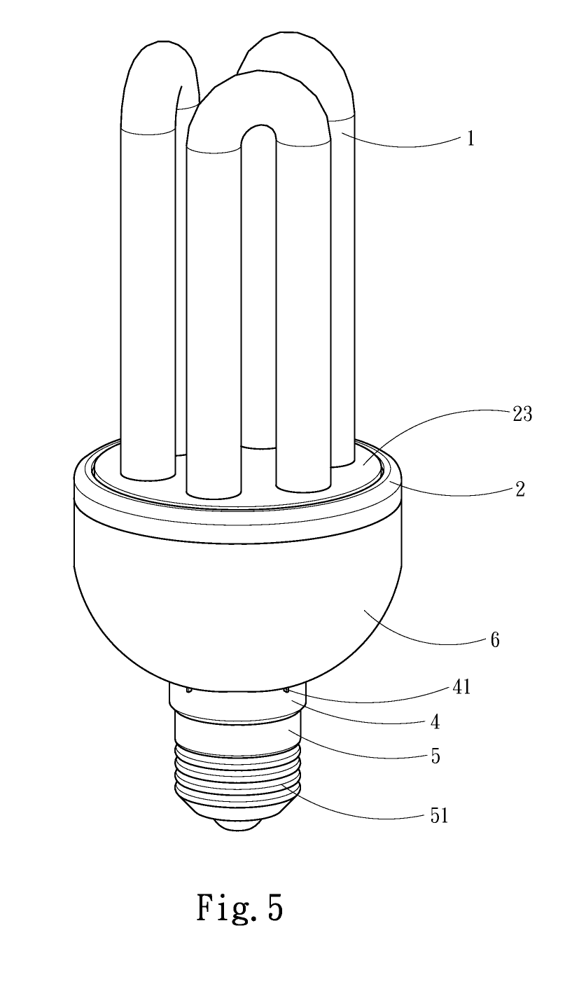

Please refer to FIG. 5, as shown, the illuminating element 1 is not restricted to be LEDs, and it also can be a lamp bulb. Besides, the ring-shaped coil 3 also can be connected with other electronic components, such as plural resistors, capacitors, inducers, ICs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat dissipating structure for a lamp, comprising:
at least an illuminating element mounted on a lamp base, which is engaged with a metal housing, wherein between the metal housing and the lamp base, a ring-shaped coil which is connected with plural electronic components is mounted, the ring-shaped coil is electrically connected to the illuminating element and a metal base, and the metal base is electrically connected to a power source, so that through a conduction of the metal base, the ring-shaped coil acquires and transforms electricity to provide to the illuminating element for operation.

2. The heat dissipating structure as claimed in claim 1, wherein the illuminating element is a lamp bulb.

3. The heat dissipating structure as claimed in claim 1, wherein the illuminating element is a LED.

4. The heat dissipating structure as claimed in claim 1, wherein a connecting element is further comprised whose two ends are respectively connected to the metal housing and the metal base.

5. The heat dissipating structure as claimed in claim 4, wherein the connecting element has a male engaging portion and the metal housing has a corresponding female engaging portion.

6. The heat dissipating structure as claimed in claim 5, wherein the male engaging portion has a slat-like shape and the female engaging portion is a slot perfectly matched therewith.

7. The heat dissipating structure as claimed in claim 1, wherein the metal housing and the lamp base respectively have a male engaging portion and a female engaging portion for engaging with each other, so as to assemble the lamp base and the metal housing together.

8. The heat dissipating structure as claimed in claim 7, wherein the male engaging portion has a slat-like shape and the female engaging portion is a slot perfectly matched therewith.

9. The heat dissipating structure as claimed in claim 1, wherein the metal housing is made of aluminum alloy.

10. The heat dissipating structure as claimed in claim 1, wherein the metal housing is made of copper alloy.

11. The heat dissipating structure as claimed in claim 1, wherein the ring-shaped coil is further connected with plural resistors, capacitors, inducers and ICs.
